(19) United States
(12) Patent Application Publication
(10) Pub. No.: US 2023/0010752 A1
(43) Pub. Date: Jan. 12, 2023

(54) WORK MACHINE HYBRID POWER UNIT

(71) Applicant: Perkins Engines Company Limited, Peterborough (GB)

(72) Inventor: John Matthew RUTLEDGE, Peterborough (GB)

(73) Assignee: Perkins Engines Company Limited, Peterborough (GB)

(21) Appl. No.: 17/784,833

(22) PCT Filed: Nov. 27, 2020
(86) PCT No.: PCT/EP2020/025546

§ 371 Date: Jun. 13, 2022

(30) Foreign Application Priority Data
Dec. 13, 2019 (GB) 1918421.7

(51) Int. Cl. B60K 6/10; E02F 9/22; F16D 43/286; F16D 48/02

(52) U.S. Cl. CPC B60K 6/105; E02F 9/2217; F16D 43/286; F16D 48/02

(57) ABSTRACT

A hybrid power unit of a work machine includes an engine and an energy storage device. The engine includes a crankshaft for driving a load and the crankshaft is attached to an energy storage device via a clutch. The energy storage device can be charged by the engine to store energy, that may be used to provide, when required, a boost to engine performance. The clutch may engage/disengage the energy storage device from the engine and/or control a clutch pressure. The clutch protects the crankshaft from shock loading and can slip to prevent over-torqueing of the crankshaft.

### BACKGROUND

This disclosure is directed to a hybrid power unit and a method for operating a hybrid power unit.

Hybrid power units, comprising an internal combustion engine and an energy storage device, may be employed in place of an internal combustion engine alone. Use of a hybrid power unit may, for example, allow a smaller displacement engine to be used for a given application, as the energy storage device may be operable to provide a power boost to fill torque gaps. A high-speed flywheel is a form of energy storage device that stores energy in the form of rotational kinetic energy. The internal combustion engine and the energy storage device may be coupled via a transmission, in order to control the rate of charging or discharging the energy storage device. If the energy storage device is a high-speed flywheel, the transmission may also manage the speed differential between the engine and the energy storage device.

A continuously variable transmission (CVT) is a known form of transmission. One known type of CVT is a metal belt CVT, which typically comprises a belt made up of metal bands and ‘vee elements’ (V-shaped elements), wherein the belt runs over a pair of vee pulleys. A vee pulley is a pulley having a V-shaped groove, formed by two frusto-conical sheaves facing each other. The distance between the sheaves can be varied to change the radius of each pulley, which enables continuous varying of the transmission ratio.

The life of a metal belt CVT may be significantly reduced by belt slip, which occurs when there is significant tangential relative motion between the belt and the pulley sheaves (for example, if the belt moves faster than the pulley rotates). This may be caused by a torque load to the CVT that exceeds its torque capability (that is, the maximum torque at which it may operate), which is a function of the clamping forces on the sheaves. To avoid belt slip, the clamping force may be increased when the torque load is increased. However, higher clamping forces may lead to a reduction in transmission efficiency from higher parasitic loads and may reduce the life of the CVT.

Using a metal belt CVT as part of a hybrid power unit with a high-speed flywheel energy storage device may expose the CVT to risk of shock loads, caused by sudden loading or unloading of the engine (which may cause a large change in engine speed relative to the speed of the high speed flywheel energy storage device). These loads may be difficult to predict. A shock load may cause the belt to slip, resulting in damage to the CVT. To address this, the CVT may be run with high clamping loads at all times. However, such a strategy may lower efficiency and increase wear.

U.S. Patent Application 2004/0209732 discloses a control system for a vehicle, which is capable of increasing the service life of a transmission belt while preventing slippage thereof, and at the same time improving fuel economy and drivability. The control system for a vehicle sets a transmission transfer torque to be transmitted from a drive pulley of a continuously variable transmission to a driven pulley of the same, and a clutch transfer torque to be transferred by a clutch. When it is determined that the vehicle is traveling on a bad road, the clutch transfer torque is reduced, and the transmission transfer torque is set to a larger value as the clutch transfer torque is larger.

### SUMMARY

According to the present disclosure, there is provided a hybrid power unit comprising an internal combustion engine and an energy storage device. The hybrid power unit further comprises a continuously variable transmission, which has a first torque capability. The continuously variable transmission comprises a first pulley mechanically coupled to the engine, and a second pulley mechanically coupled to the energy storage device. A torque fuse, having a second torque capability, is disposed between the first pulley and the engine. The second torque capability (of the torque fuse) is operable to be modified to be less than the first torque capability (of the continuously variable transmission).

Optionally, the torque fuse comprises a clutch.

Optionally, the continuously variable transmission is a metal belt continuously variable transmission.

Optionally, the energy storage device is a flywheel.

Optionally, the second torque capability is operable to be modified by the torque fuse and/or by a transmission control system.

The disclosure further provides a method of operating a hybrid power unit according to the disclosure. The method comprises the step of determining the first torque capability. The method further comprises the step of modifying the second torque capability to be less than the first torque capability.

Optionally, modifying the second torque capability to be less than the first torque capability comprises modifying the second torque capability to be a proportion of the first torque capability. Optionally, the proportion is selected from a range of from 0.75 to 0.95.

Optionally, the second torque capability is a function of a friction coefficient of the torque fuse. Optionally, the method further comprises the step of revising a stored value for the friction coefficient.

### BRIEF DESCRIPTION OF THE DRAWINGS

Embodiments of the present disclosure will now be described, by way of example only, with reference to the accompanying drawings, in which:

FIG. 1 shows a schematic of a hybrid power unit according to the present disclosure; and

FIG. 2 shows a flowchart depicting modes of operation for a transmission control system for the hybrid power unit of FIG. 1.

### DETAILED DESCRIPTION

A hybrid power unit of a work machine comprises an engine and an energy storage device.

The engine includes a crankshaft for driving an application load, which may be a work tool or the like, and/or an accessory load, such as an air conditioning compressor. The energy storage device may be a flywheel or the like and may be mechanically coupled to the engine. The energy storage device may be charged by the engine, for example passively by recovering braking energy, or by active charging to achieve a target energy level. Energy stored in the energy storage device may be used to provide a torque boost to increase engine transient response, or to fill any torque deficits resulting from engine downsizing. The energy storage device may be mechanically coupled to the engine via a transmission system.

The transmission system may be a continuously variable transmission (CVT). The transmission system may be electronically coupled to a transmission control system, which may electronically control operation of the transmission system. The transmission system may include a clutch. The clutch may engage/disengage the energy storage device from the engine and/or may control a clutch pressure.

The clutch may protect the CVT against slip-induced damage due to shock loading, which may be caused by sudden loading or unloading of the engine. The clutch may act as a ‘weak link’, whereby the clutch may slip in a situation of over-torque due to shock loading, thereby preventing the belt of the CVT from slipping. The clutch may have a torque capability, which may be a maximum torque at which the clutch may operate. The clutch torque capability may be variable, such that it may be modulated to be increased or decreased with, but always remain less than, a torque capability of the CVT. This may allow the transmission system to take advantage of the full torque capability of the CVT, whilst protecting the belt of the CVT from slipping.

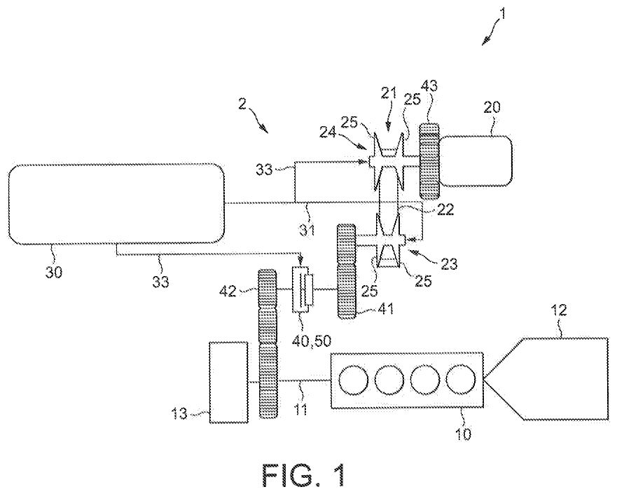

FIG. 1 illustrates a schematic of a hybrid power unit 1 according to the present disclosure. The hybrid power unit 1 comprises an engine 10 and an energy storage device 20. The hybrid power unit 1 may be employed on a work machine, such as a wheel loader, backhoe loader, excavator, dozer, or the like.

The engine 10 may be an internal combustion engine. The engine 10, which may have a crankshaft 11, may be configured to drive an application load 12. The application load 12 may represent the core work of the engine 10, for example use of one or more work tools associated with the work machine, or the drive train of the work machine. The engine 10 may further be configured to run an accessory load 13, which may include any subsidiary loads such as the work machine's alternator, air conditioning compressor, fan, or other accessory loads.

The energy storage device 20 may comprise a flywheel, optionally a high-speed flywheel. The energy storage device 20 may be mechanically coupled to the engine 10. The energy storage device 20 may be charged by the engine 10, for example passively by recovering braking energy, or by active charging to achieve a target charge level. Energy stored in the energy storage device 20 may be used to provide a torque boost to increase engine transient response, or to fill any torque deficits resulting from engine downsizing. The energy storage device 20 may be mechanically coupled to the engine 10 via a transmission system 2.

The transmission system 2 may comprise a CVT 21. The CVT 21 may comprise a belt 22 arranged to run over first and second pulleys 23,24. Each of the first and second pulleys 23,24 may comprise two opposing frusto-conical sheaves 25. One of the sheaves 25 may be fixed, with the other sheave 25 being movable in an axial direction. Varying the axial distance between the sheaves 25 of the first or second pulley 23,24 may cause the belt 22 to move radially outward or inward with respect to the sheaves 25, thereby varying the effective radius of the respective first or second pulley 23,24. This enables a transmission ratio between the first and second pulleys 23,24 to be continuously varied. Optionally, the belt 22 may be made of metal. Optionally, the belt 22 may be made of rubber.

The transmission system 2 may be electronically coupled to a transmission control system 30, which may electronically control operation of the transmission system 2 at least by controlling a first pulley pressure 31, being a hydraulic pressure to a piston controlling the movable sheave 25 of the first pulley 23, and a second pulley pressure 32, being a hydraulic pressure to a piston controlling the movable sheave 25 of the second pulley 24. By varying the first or second pulley pressure 31,32, a clamping force on the belt 22 between the sheaves 25 of the respective first or second pulley 23,24 may be varied. Increasing or decreasing the clamping force on first or second pulley 23,24 away from a force that gives equilibrium at a current transmission ratio (of the CVT 21) and a current belt torque load will act to vary an axial distance between the sheaves 25 of the respective first or second pulley 23,24.

The first pulley 23 may be mechanically coupled to the engine 10. For example, the first pulley 23 may be coupled to the engine crankshaft 11, or to a drive transmission (not shown) of the engine 10. The second pulley 24 may be mechanically coupled to the energy storage device 20. For example, the second pulley may be mechanically coupled to an input shaft of the energy storage device 20. When charging the energy storage device 20, the first pulley 23 may be the primary pulley and the second pulley 24 may be the secondary pulley.

The transmission system 2 may further comprise a clutch 40. The clutch 40 may be disposed between the first pulley 23 and the engine 10. The clutch 40 may in some embodiments be a friction clutch. The clutch 40 may be operable to engage/disengage the energy storage device 20 from the engine 10 and the accessory load 13. The transmission control system 30 may be operable to control a clutch pressure 33, which may be a pressure in a piston of the clutch 40.

The transmission system 2 may further comprise one or more gear sets. A first gear set 41 may be disposed between the first pulley 23 and the clutch 40. The first gear set 41 may be any suitable type of gear set. Optionally, the first gear set 41 may be a spur gear set. A second gear set 42 may be disposed between the clutch 40 and the engine 10. The second gear set 42 may be any suitable type of gear set. Optionally, the second gear set 42 may be a spur gear set. A third gear set 43 may be disposed between the second pulley 24 and the energy storage device 20. The third gear set 43 may be any suitable gear set. Optionally, the third gear set 43 may be a planetary gear set.

In an alternative embodiment, a further clutch (not shown) may be disposed between the second gear set 42 and the engine 10. In this embodiment, energy stored in the energy storage device 20 may be used to run the accessory load 13 when the engine 10 is off.

The transmission system may comprise a torque fuse 50. The torque fuse 50 may be provided between the CVT 21 and the engine 10, in particular between the first pulley 23 and the engine 10. The torque fuse 50 may protect the CVT 21 against slip-induced damage due to shock loading, which may be caused by sudden loading or unloading of the engine 10. The torque fuse 50 may act as a weak link operable to slip in a situation of over-torque due to shock loading, thereby preventing the belt 22 of the CVT 21 from slipping. The CVT 21 may have a first torque capability, which may be a maximum torque at which the CVT 21 may operate without the belt 22 slipping. The torque fuse 50 may have a second torque capability, which may be a maximum torque at which it may operate without the torque fuse 50 slipping. The second torque capability may be less than the first torque capability. That is, the torque capability (or maximum torque) of the torque fuse 50 may be less than the torque capability (or maximum torque) of the CVT 21. As a result, the torque fuse 50 may be operable to slip at a torque level below the torque capability of the CVT 21. The torque capability of the CVT 21 may vary with a clamping pressure of the CVT 21, determined by the first and second pulley pressures 31,32. In order to be able to take advantage of the full torque capability of the CVT 21, the torque capability of the torque fuse 50 may also be variable.

The person skilled in the art will recognise that any gear sets between components such as the engine 10, the torque fuse 50, and the CVT 21 (such as the first and second gear sets 41,42) may act to modify the torque transmitted by way of gear reduction, meshing, and other losses. For the sake of simplicity, it is assumed herein that any gear sets that may be present have 1 to 1 ratios and are loss free. For any potential embodiments with gear set ratios other than 1 to 1, it will be understood by the person skilled in the art that the torque capability of any component referred to is the torque capability of the component as seen from the input of the transmission system 2 (that is, at the point of connection of the transmission system 2 to the engine 10), with the torque capability of the component being adjusted by any gear set ratios or losses.

The torque fuse 50 may comprise the clutch 40. A torque capability of the clutch 40 may be varied by varying the clutch pressure 33. The clutch pressure 33 may be varied so-as-to modulate the torque capability of the of the clutch 40 to increase with, but remain less than, the torque capability of the CVT 21. This may enable the CVT 21 to run at lower clamping pressures at low load conditions, as instead of shock loads causing the CVT 21 to slip, the clutch 40 may slip instead.

The clutch pressure 33 may be modified such that the clutch 40 is operable to slip at a torque that is a proportion of the CVT 21 torque capability. That is, the clutch pressure 33 may be modified such that the clutch 40 torque capability is a proportion of the CVT 21 torque capability. The proportion may be in a range of 0.75 to 0.95, optionally 0.80 to 0.92, optionally 0.90. To calculate the clutch pressure 33, a relationship may be defined between the clutch pressure 33 and the CVT 21 torque capability, as set out below.

The relationship between clamping force and torque capability (or maximum torque) for each of the first and second pulleys 23,24 may generally be defined as:

$${F}_{K} = \frac{\vert {τ}_{MAX , pulley} \vert \times cos β}{2 \times {R}_{i} \times μ}$$

where F_{K} is the clamping force, τ_{MAX,pulley} is the maximum torque of the pulley, β is the sheave angle, Rᵢ is the radius of the first or second pulley 23,24, and μ is the coefficient of friction between the belt 22 and the first or second pulley 23,24.

Adding in a safety factor σ results in:

$${F}_{K} = \frac{\vert {τ}_{MAX , pulley} \vert \times cos β \times σ}{2 \times {R}_{i} \times μ}$$

A suitable safety factor may be selected from a range of from 1.15 to 1.5, optionally 1.3.

The maximum torque of the first or second pulley 23,24 can be defined as:

$${τ}_{MAX , pulley} = \frac{2 \times {R}_{i} \times μ}{cos β \times σ} \times {A}_{piston , pulley} \times {P}_{piston}$$

where A_{piston,pulley} is an area or the pulley piston and Pₚᵢₛₜₒₙ is a pressure acting on the pulley piston.

The clutch 40 torque capability can be defined as

τ_{MAX,clutch}=N_{disc}×A_{disc}×μ_{disc,static}×D_{cl}×(A_{piston,clutch}×P_{clutch}−F_{spring,clutch})

where τ_{MAX,clutch} is the maximum torque of the clutch 40, N_{disc} is a number of clutch discs, A_{disc} is an area of the clutch discs, μ_{disc,static} is the clutch 40 friction coefficient, D_{cl} is an effective diameter of the clutch 40, A_{piston,clutch} is an area of the clutch piston, P_{clutch} is a pressure in the clutch piston (including any rotational effects), and F_{spring,clutch} is a force from the clutch spring (assumed normally open).

The relationship between the torque of the first or second pulley 23,24 and the clutch 40, due to gearing between them, is:

$${T}_{pulley} = \frac{{T}_{clutch}}{{Ratio}_{pulley : clutch}}$$

where T_{pulley} is a torque on the first or second pulley 23,24, T_{clutch} is a torque on the clutch 40, and Ratio_{pulley:clutch} is speed of the first or second pulley 23,24 divided by speed of the clutch 40.

Thus, the clutch 40 torque when the first or second pulley 23,24 is at a proportion α of its capability is:

$${T}_{clutch} = ∝ \times {Ratio}_{pulley : clutch} \times \frac{2 \times {R}_{i} \times μ}{cos β \times σ} \times {A}_{piston , pulley} \times {P}_{piston}$$

Again, the proportion ∝ may be in a range of 0.75 to 0.95, optionally 0.80 to 0.92, optionally 0.90.

The clutch pressure 33 at the maximum torque limit is:

$${P}_{clutch} = \frac{1}{{A}_{piston , clutch}} \times ( {F}_{spring , clutch} + \frac{{τ}_{MAX , clutch}}{{N}_{disc} \times {A}_{disc} \times {μ}_{disc , static} \times {D}_{cl}} )$$

Thus, the clutch pressure 33 required to cause the clutch 40 to slip at a proportion ∝ of the torque capability of the first or second pulley 23,24 is:

$${P}_{clutch} = \frac{1}{{A}_{piston , clutch}} \times ( {F}_{spring , clutch} + \frac{∝ \times {Ratio}_{pulley : clutch} \times \frac{2 \times {R}_{i} \times μ}{cos β \times σ} \times {A}_{piston , pulley} \times {P}_{piston}}{{N}_{disc} \times {A}_{disc} \times {μ}_{disc , static} \times {D}_{cl}} )$$

The transmission control system 30 may calculate P_{clutch} in relation to each of the first and second pulleys 23,24, with the clutch pressure 33 being set as the lower of the two values. Thus the CVT 21 torque capability may be considered to be the lower of the first pulley 23 torque capability and the second pulley 24 torque capability.

Rotation of hydraulic fluid in the clutch 40 piston may result in centrifugal pressure effects, which may cause pressure in the clutch 40 piston to increase with distance from its axis of rotation. Thus, for the same hydraulic fluid pressure supplied at the axis of the piston, the total piston force may increase with speed, which may affect P_{clutch}. In some embodiments, such effects may be counteracted by providing the clutch 40 with a balance piston. In some embodiments, the balance piston may comprise a volume of hydraulic fluid of substantially similar size to that in the clutch 40 piston, which may generate is own centrifugal head pressure to create a force to oppose the force from the centrifugal head pressure in the clutch 40 piston.

In some embodiments, where a balance piston is not used, a speed dependent adjustment may be made to P_{clutch}. In such embodiments, P_{clutch} may be reduced so that the net force on the clutch 40 piston from the hydraulic fluid pressure is reduced by an amount equal to the force exerted by the centrifugal head pressure. The reduction of P_{clutch} may vary with clutch 40 speed and with temperature of the hydraulic fluid. The reduction of P_{clutch} may be pre-calculated and stored within the transmission control system 30, or it may be calculated by the transmission control system 30 based on clutch 40 speed, temperature of the hydraulic fluid, and dimensions of the clutch 40.

Due to wear of the clutch 40 through use, or part-to-part variability if the clutch 40 is replaced, the clutch 40 friction coefficient μ_{disc,static} may change with time. To account for this, in some embodiments of the present disclosure, the transmission control system 30 may carry out a slip test to assess the accuracy of the value used for the clutch 40 friction coefficient μ_{disc,static}, and to revise it if necessary. The slip test is described below.

Although the physical configuration of the transmission control system 30 is not illustrated, it may comprise a plurality of conventional electronic components, analogue-to-digital converters, input-output devices, solenoid drivers, electronic circuitry, and one or more processors. It is to be understood that the one or more processors may comprise one or more microprocessors, controllers, or any other suitable computing devices, resource, hardware, software, or embedded logic. The transmission control system 30 may comprise memory in the processors, main memory, and/or hard disk drives, which carries a set of non-transient machine readable instructions or software/code which, when executed by the one or more processors, causes the transmission control system 30 to operate in a normal operation mode 60, an idle mode 61, or in a slip test mode 62.

The transmission control system 30 may comprise a plurality of components or modules, which may correspond to the functional tasks to be performed thereby. In this regard, the term ‘module’ will be understood to include an identifiable portion of code, computational or executable instructions, data, or computational object to achieve a particular function, operation, processing, or procedure. It follows that a module need not be implemented in software; a module may be implemented in software, optionally hardware, or a combination of software and hardware. Further, the modules need not necessarily be consolidated into one system, but may be spread across a plurality of other devices and systems to provide the functionality described herein. In some embodiments, the one or more processors, executing the aforementioned machine readable instructions or software/code, may effectively provide the modules, or the functionality thereof, as described herein.

As an alternative, the transmission control system 30 may comprise an analog or electromechanical device.

The transmission control system 30 may be part of a main machine control system (not shown), which may control other functions of the work machine. The machine control system may be of any suitable known type, and may comprise an engine control unit (ECU) or the like. The machine control system may comprise a memory, which may store instructions or algorithms in the form of data, and a processing unit, which may be configured to perform operations based upon the instructions. The memory may comprise any suitable computer-accessible or non-transitory storage medium for storing computer program instructions, such as RAM, SDRAM, DDR SDRAM, RDRAM, SRAM, ROM, magnetic media, optical media and the like. The processing unit may comprise any suitable processor capable of executing memory-stored instructions, such as a microprocessor, uniprocessor, a multiprocessor and the like, Alternatively, the transmission control system 30 may be an independent control unit connected electronically to the machine control system.

### INDUSTRIAL APPLICABILITY

The hybrid power unit 1 has industrial applicability in the field of machines, in particular work machines, such as wheel loaders, backhoe loaders, excavators, dozers, and the like.

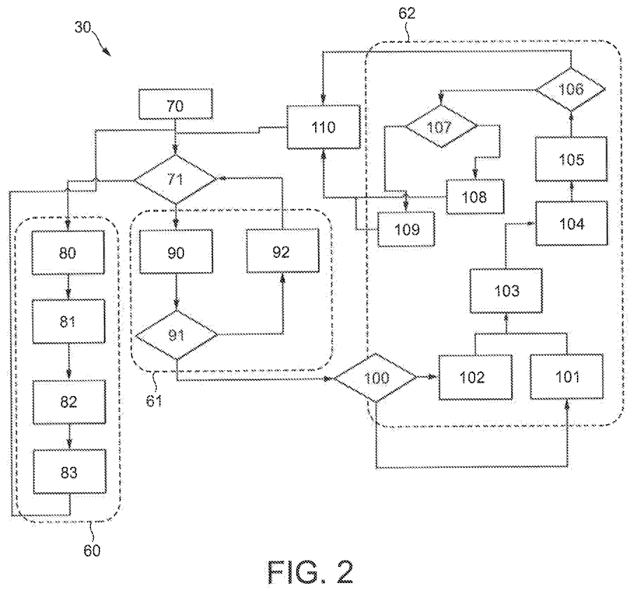

In use, as depicted in the flowchart of FIG. 2, the transmission control system 30 may operate in a normal operation mode 60, an idle mode 61, or in a slip test mode 62.

After start-up of the power unit 1, when an engine 10 and energy storage device 20 start-up sequence has been completed (such that the engine 10 is running and the energy storage device 20 is coupled to the engine 10 via the CVT 21 and is running) (at box 70 of the flowchart), at box 71 the transmission control system 30 may substantially continuously monitor whether the engine 10 is at idle. If the engine 10 is not at idle, the transmission control system 30 may enter the normal operation mode 60. If the engine 10 is at idle, the transmission control system 30 may enter the idle mode 61.

If the transmission control system 30 enters the normal operation mode 60, at box 80 an idle time counter may be set to zero. At box 81, the transmission control system 30 may then determine the state of the first and second pulleys 23,24 (for example the first and second pulley pressures 31,32, speed, etc.). This information may be recorded to calculate the torque capability of each of the first and second pulleys 23,24. The lower of these two values may be used as the effective CVT 21 torque capability. At box 82, the transmission control system 30 may then calculate a clutch pressure 33 to give a clutch 40 torque capability of a proportion a of the CVT 21 torque capability. Again, the proportion ac may be in a range of 0.75 to 0.95, optionally 0.80 to 0.925, optionally 0.90. The clutch pressure 33 may be calculated using a value stored by the transmission control system 30 for the clutch 40 friction coefficient μ_{disc,static}. At box 83, the transmission control system 30 may then set the clutch pressure 33 to the calculated value. This may ensure that, in the event of a torque spike, the clutch 40 will slip before the belt 22 of the CVT 21, thereby protecting the CVT 21 from damage.

If the transmission control system 30 enters the idle mode 61, at box 90 the transmission control system 30 may increment an idle time counter (which may have been set to zero in the normal operation mode 60 (box 80)), and determine how long the engine 10 has been at idle. The transmission control system 30 may also determine how much time has passed since the last slip test was completed. At box 91, the transmission control system 30 may determine whether both a predetermined minimum time at idle and a predetermined minimum interval between slip tests have been met. If one or both of these requirements have not been met, the transmission control system 30 may remain in the idle mode 61 and proceed to box 92, where the clutch pressure 33 may be set to a predetermined idle value.

If both the minimum time at idle and the minimum interval between slip tests have been met, the transmission control system 30 may enter the slip test mode 62. The two requirements may ensure that the slip test is not performed overly frequently, to avoid excessive fuel burn and operator disturbance.

After entering the slip test mode 62, at box 100 the transmission control system 30 may check whether the stored value for the clutch 40 friction coefficient μ_{disc,static} was revised in an immediately preceding slip test. The slip test may be carried out at a nominal acceleration rate (or a ‘first acceleration rate’) for the energy storage device 20. For example, if the energy storage device 20 is a flywheel, at a nominal acceleration of the flywheel. The nominal acceleration rate may be selected to be safely below a maximum acceleration rate of the energy storage device 20. For example, the nominal acceleration rate may be selected to be 50% to 75% of the maximum acceleration rate of the energy storage device 20. Optionally, the nominal acceleration rate may be selected to be 60% of the maximum acceleration rate of the energy storage device 20. The nominal acceleration rate may remain constant for all slip tests.

An assumed acceleration rate (or a ‘second acceleration rate’) for the energy storage device 20 may be used to calculate the clutch 40 torque capability for calculating the clutch pressure 33 for the slip test. For the first slip test (or the first slip test after the stored value for the clutch 40 friction coefficient μ_{disc,static} has been revised), at box 101 the assumed acceleration rate may be set to be a maximum assumed acceleration rate, which may be higher than the nominal acceleration rate. For example, the assumed acceleration rate may be set to be 5% to 25% higher than the nominal acceleration rate. Optionally, the assumed acceleration rate may be set to be 10% higher than the nominal acceleration rate. This may mean that the clutch pressure 33 may be set to be higher (for example, 10% higher) than would be required to avoid slipping from the torque it will be subjected to when the energy storage device 20 is charged at the nominal acceleration rate (assuming that the stored value for the clutch 40 friction coefficient μ_{disc,static} is correct).

If the previous slip test did not cause the clutch 40 to slip (such that the stored value for the clutch 40 friction coefficient μ_{disc,static} was not revised), at box 102 the assumed acceleration rate may be reduced for the present slip test, such that the clutch pressure 33 will be reduced and therefore the clutch 40 may be more likely to slip. For example, the assumed acceleration rate may be reduced by 1% to 5% of the nominal acceleration rate. Optionally, the assumed acceleration rate may be reduced by 2% of the nominal acceleration rate. The assumed acceleration rate may be further reduced during subsequent slip tests until a slip event occurs, wherein the clutch 40 slips.

Following a slip event, the stored value for the clutch 40 friction coefficient μ_{disc,static} may be revised, with the subsequent slip test being carried out with the maximum assumed acceleration rate again, such that the assumed acceleration rate is set to be higher than the nominal acceleration rate. However, due to modification of the stored value for the clutch 40 friction coefficient μ_{disc,static}, the clutch pressure 33 may be different despite the assumed acceleration rate returning to a previous value.

At box 103, the transmission control system 30 may calculate the clutch pressure 33 based on the assumed acceleration rate, with the clutch pressure 33 being set at box 104. At box 105, the transmission control system 30 may set the CVT 21 ratio to cause the energy storage device 20 to charge at the nominal acceleration rate. At box 106, the transmission control system 30 may check whether the clutch 40 slipped during the charge event. If the stored value for the clutch 40 friction coefficient μ_{disc,static} is correct, the clutch 40 should not slip if the assumed acceleration rate is set to be higher than the nominal acceleration rate, whereas the clutch 40 should slip if the assumed acceleration rate is set to be lower than the nominal acceleration rate.

If the clutch 40 slipped during the charge event, at box 107 the transmission control system 30 may first check whether the assumed acceleration rate for the present slip test was higher or lower than the nominal acceleration rate. If the assumed acceleration rate for the present slip test was higher than the nominal acceleration rate and the clutch 40 slipped during the charge event, it may mean that the actual coefficient of friction of the clutch 40 is lower than the stored value for the clutch 40 friction coefficient μ_{disc,static} used to calculate the clutch pressure 33 for the present slip test. Thus, at box 108 the stored value for the clutch 40 friction coefficient μ_{disc,static} may be revised by reducing it. The scale of the reduction in the stored value for the clutch 40 friction coefficient μ_{disc,static} may be related to how much higher the assumed acceleration rate was than the nominal acceleration rate. If the assumed acceleration rate for the present slip test was lower than the nominal acceleration rate and the clutch 40 slipped during the charge event, it may mean that the actual coefficient of friction of the clutch 40 is higher than the stored value for the clutch 40 friction coefficient μ_{disc,static} used to calculate the clutch pressure 33 for the present slip test. Thus, at box 109 the stored value for the clutch 40 friction coefficient μ_{disc,static} may be revised by increasing it. The scale of the increase in the stored value for the clutch 40 friction coefficient μ_{disc,static} may be related to how much lower the assumed acceleration rate was than the nominal acceleration rate.

After the stored value for the clutch 40 friction coefficient μ_{disc,static} has been updated (at box 108 or 109), or if the clutch 40 did not slip during the charge event (as checked at box 106), at box 110 the CVT 21 ratio is gradually altered to reduce the speed of the energy storage device 20 to its normal speed at idle.

1. A hybrid power unit comprising:
an internal combustion engine;
an energy storage device;
a continuously variable transmission comprising a first pulley mechanically coupled to the engine and a second pulley mechanically coupled to the energy storage device, the continuously variable transmission having a first torque capability; and
a torque fuse disposed between the first pulley and the engine, the torque fuse having a second torque capability; wherein
the second torque capability is operable to be modified to be less than the first torque capability.

2. A hybrid power unit according to claim 1, wherein:
the torque fuse comprises a clutch;
and/or the continuously variable transmission comprises a metal belt continuously variable transmission; and/or the energy storage device comprises a flywheel,

3. A hybrid power unit according to claim 1, wherein the second torque capability is operable to be modified by the torque fuse and/or by a transmission control system.

4. A hybrid power unit according to claim 1, wherein the second torque capability is a function of a friction coefficient of the torque fuse, and further comprising a transmission control system, wherein the transmission control system is operable to revise a stored value for the friction coefficient.

5. A hybrid power unit according to claim 1, wherein the first pulley has a third torque capability and the second pulley has a fourth torque capability, and wherein the first torque capability is the lower value of the third torque capability and the fourth torque capability.

6. A hybrid power unit according claim 1, wherein the first pulley is mechanically coupled to a crankshaft of the engine or to a transmission of the engine.

7. A method of operating a hybrid power unit according to claim 1, the method comprising the steps of:
determining the first torque capability; and
modifying the second torque capability to be less than the first torque capability.

8. A method according to claim 7, wherein modifying the second torque capability to be less than the first torque capability comprises modifying the second torque capability to be a proportion of the first torque capability, wherein the proportion is selected from a range of from 0.75 to 0.95.

9. A method according to claim 7, wherein the second torque capability is a function of a friction coefficient of the torque fuse, and further comprising the step of revising a stored value for the friction coefficient.

10. A method according to claim 9, wherein the step of revising a stored value for the friction coefficient comprises the steps of:
selecting a first acceleration rate for the energy storage device;
selecting a second acceleration rate for the energy storage device, wherein the second acceleration rate is less than or greater than the first acceleration rate;
modifying the second torque capability such that the torque fuse is operable to slip at the second acceleration rate;
accelerating the energy storage device at the first acceleration rate;
determining whether the torque fuse slips; and
if the torque fuse slips, revising the stored value for the friction coefficient.

11. A method according to claim 10, wherein the second acceleration rate is less than the first acceleration rate, and wherein revising the friction coefficient comprises increasing the stored value for the friction coefficient.

12. A method according to claim 10, wherein the second acceleration rate is greater than the first acceleration rate, and wherein revising the friction coefficient comprises reducing the stored value for the friction coefficient.

13. A method according to claim 9, wherein the step of revising the friction coefficient is effected when the engine is at idle.

14. A method according to claim 7, further comprising the step of modulating the second torque capability to increase/decrease with, but remain less than, the first torque capability.

15. A method according to claim 7, wherein the torque fuse comprises a clutch having a clutch pressure, and further comprising the step of modifying the clutch pressure to achieve the second torque capability.
